(19) United States
(12) Patent Application Publication
(10) Pub. No.: US 2006/0133496 A1
(43) Pub. Date: Jun. 22, 2006

(54) Motion estimation method for an adaptive dynamic search range

(75) Inventor: Chung-Hsien Tsai, Taipei (TW)

Correspondence Address: BIRCH STEWART KOLASCH & BIRCH, PO BOX 747, FALLS CHURCH, VA, 22040-0747, US

(73) Assignee: Ali Corporation

(21) Appl. No.: 11/177,344

(22) Filed: Jul. 11, 2005

(30) Foreign Application Priority Data
Dec. 21, 2004 (TW) 93139908

(51) Int. Cl. H04N 11/02; H04N 7/12; H04N 11/04; H04B 1/66

(52) U.S. Cl. 375/240.16; 375/240.12; 375/240.24

(57) ABSTRACT

A motion estimation method for an adaptive dynamic search range is provided to solve the problems of reading a large quantity of reference frame data for a search and having an insufficient bandwidth of the dynamic random access memory. The invention uses a component of a motion estimation vector of a predictor and the position of its present macroblock data to determine a predicted position, and the estimation method for an adaptive dynamic search range is carried out to determine the search range, and a uniform distribution quantified hierarchical method is used to reduce the power consumption and area. Therefore, the invention can effectively lower the bandwidth of the dynamic random access memory (compared with the algorithm of a fixed search range) and reduce the overall power consumption and effectively maintain the original compression quality.

### BACKGROUND OF THE INVENTION

1. Field of the Invention

The present invention relates to a motion estimation method for an adaptive dynamic search range, more particularly to a motion estimation method for an adaptive dynamic search range that uses components of a motion estimation vector of a predictor and corresponding positions of macroblock data to determine a predicted position and further carries out the motion estimation method for an adaptive dynamic search range.

2. Description of Related Art

Video sequence consists of a series of frames, and motion estimation is a method of finding a motion in each region between two adjacent frames of video data. Motion estimation is a very important technology to video compression standards. With reasonable assumptions, the video sequences of two adjacent frames are similar to each other. The motion estimation can find and eliminate similar portions, and the remaining different portions are compressed by transcoding and run length encoding to effectively achieve a high compression ratio.

As to prior arts, R.O.C. Patent Publication No. 535440 entitled “Motion estimation method for video coding” discloses an estimation method for video coding by using a predicted point of a motion vector. The row of a predicted point of a motion vector is set as Row p, and two consecutive rows prior to and next to Row p are set to Row p+1 and Row p−1 respectively. The differences among all corresponding points located at Row p, Row p+1 and Row p−1 are computed, and a minimum deviation is obtained by comparing the difference. The minimum deviation is examined to determine whether its value falls into Row p, Row p+1 or Row p−1 so as to obtain the motion vector.

Further, R.O.C. Patent Publication No. 550952 entitled “Method for detecting a video change in compressed video data” discloses a method for detecting a change of the images in a compressed video data. Firstly, the time code recorded in the compressed video data corresponding to two consecutive video frames in user data area is read, and then the time interval of the two time codes are compared to determine whether the time interval is larger than a standard time interval. If the time interval is larger than the standard time interval, then it is determined that there is a change of the images between the two consecutive video frames.

In the MPEG compression specification, a maximum range for integral points of a motion estimation vector is defined, which is known as an image scaling information (F_CODE), which restricts the integral values of the motion estimation vector so obtained must fall within this range. In general, the image scaling information is set with a large value to make sure that the relative positions for two consecutive pictures with motions can be found precisely, and thus increasing its compression ratio. However, such setup reads a great deal of data of the reference frames when a data is searched, and thus causing insufficient bandwidth for the dynamic random access memory.

### SUMMARY OF THE INVENTION

In view of the foregoing shortcomings of the prior arts that a large quantity of reference frame data is read for searching a data and an sufficient bandwidth for the dynamic random access memory is resulted, the inventor of the present invention conducted extensive researches and put theories into practices, and finally invented a motion estimation method for an adaptive dynamic search range.

Therefore, it is a primary objective of the present invention to provide a motion estimation method for an adaptive dynamic search range by using components of a motion estimation vector of a predictor and corresponding positions of macroblock data to determine the length and width of the search range.

To achieve the foregoing objective, the motion estimation method for an adaptive dynamic search range in accordance with the present invention comprises the steps of: installing a direction predictor of a macroblock data; determining whether or not the direction predictor is the smallest total absolute deviation and the smallest total absolute deviation is smaller than a critical value; and determining whether or not a direction component of a motion estimation vector of a macroblock data is smaller than a critical value of a motion estimation vector; thereby the prediction direction and the search range of the macroblock data can be determined.

### BRIEF DESCRIPTION OF THE DRAWINGS

FIG. 1 is a flow chart of a motion estimation method for an adaptive dynamic search range in accordance with the present invention;

FIGS. 2A and 2B are detailed flow charts of a motion estimation method for an adaptive dynamic search range in accordance with the present invention; and

FIG. 3 is a flow chart of a computing method for a total absolute deviation in accordance with the present invention.

### DETAILED DESCRIPTION OF THE PREFERRED EMBODIMENTS

To make it easier for our examiner to understand the technology, method and objective to achieve the objectives of the invention, the following detailed description of a preferred embodiment together with the attached drawings are given, such that the objective, features and advantages of present invention will become apparent. However, the invention is not intended to be limited by the drawings which are provided for reference and the sake of clarity only.

In the technical specification of the prior art MPEG compression, a large quantity of reference frame data is read during a search and the problem of having insufficient bandwidth for the dynamic random access memory occurs. Therefore, the present invention provides a motion estimation method for an adaptive dynamic search range, and the method comprises the steps of producing a full search range according to the image scaling information and the current position of a macroblock data such that a finally obtained motion estimation vector must fall into this range; using a predictor to estimate a required partial search range, wherein the partial search range can be adjusted into the full search range automatically, and the range can only be equal to or smaller than the full search range. The partial search range has a larger flexibility and thus the present invention provides a motion estimation method for an adaptive dynamic search range, such that the partial search range varies according to the similarly and the motion vector of the predictor to effectively lower the using bandwidth of the dynamic random access memory (compared with the algorithm for a fixed search range) and effectively maintains its original compression quality.

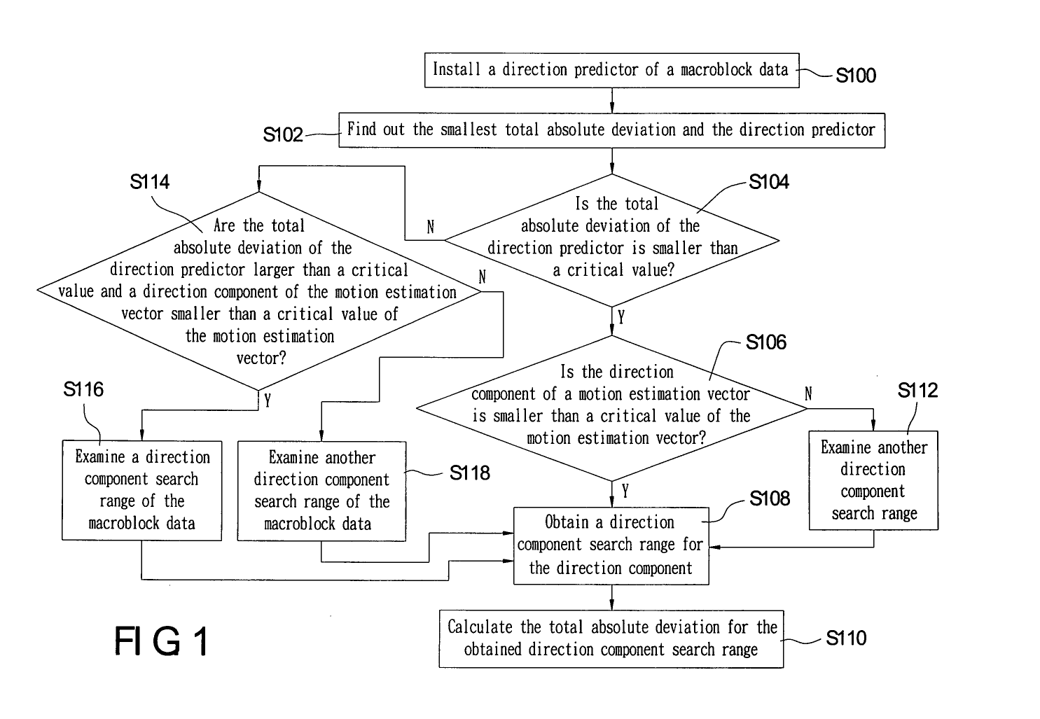

Referring to FIG. 1, a flow chart of a motion estimation method for an adaptive dynamic search range in accordance with the present invention is illustrated. The method comprises the steps: (S100) installing a direction predictor of a macroblock data; (S102) finding out a direction predictor with the smallest total absolute deviation; (S104) determining whether or not the total absolute deviation of the direction predictor is smaller than a critical value; (S106) determining whether or not a direction component of a motion estimation vector of the macroblock data is smaller than a critical value of the motion estimation vector, if the determination result obtained from (S104) is affirmative; (S108) obtaining a direction component search range of the direction component, if the determination result obtained from (S106) is affirmative; and (S110) calculating a total absolute deviation of the obtained direction component search range; (S112) examining another set of direction component search range of the macroblock data, if the determination result obtained from (S106) is negative; (S114) obtaining a total absolute deviation larger than a critical value and determining whether or not a direction component of a motion estimation vector of the total absolute deviation is smaller than a critical value of the motion estimation vector, if the determination result obtained from (Step 104) is negative; (S116) examining a direction component search range of the macroblock data, if the determination result obtained from (S114) is affirmative; and (S118) examining another set of direction component search range, if the determination result obtained from (S114) is negative.

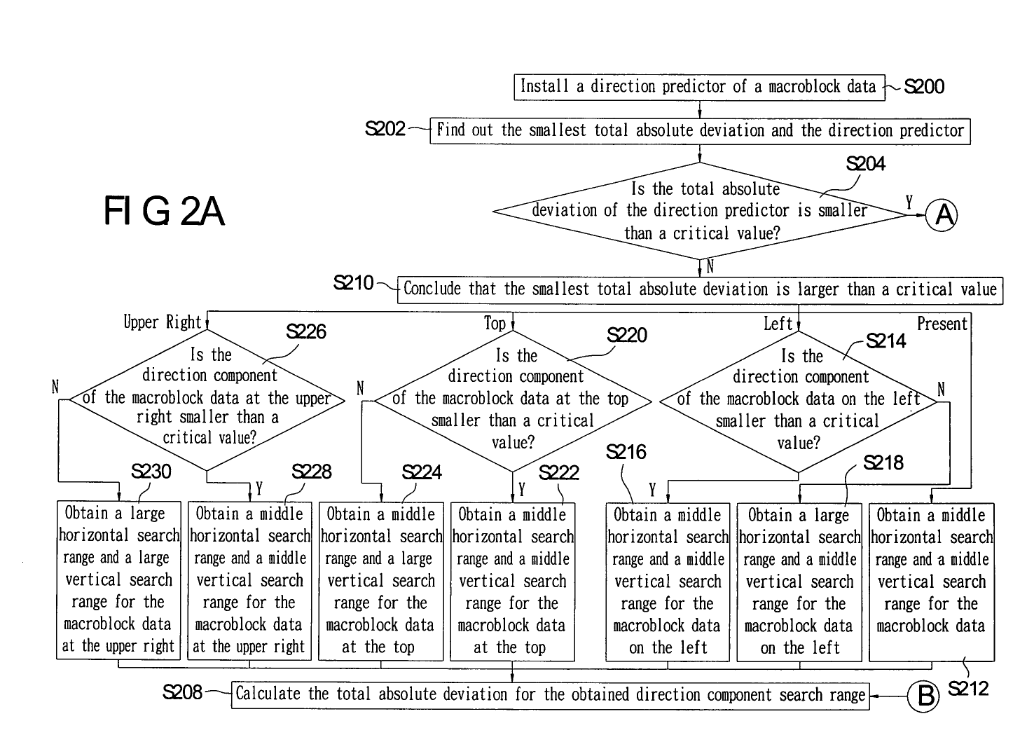

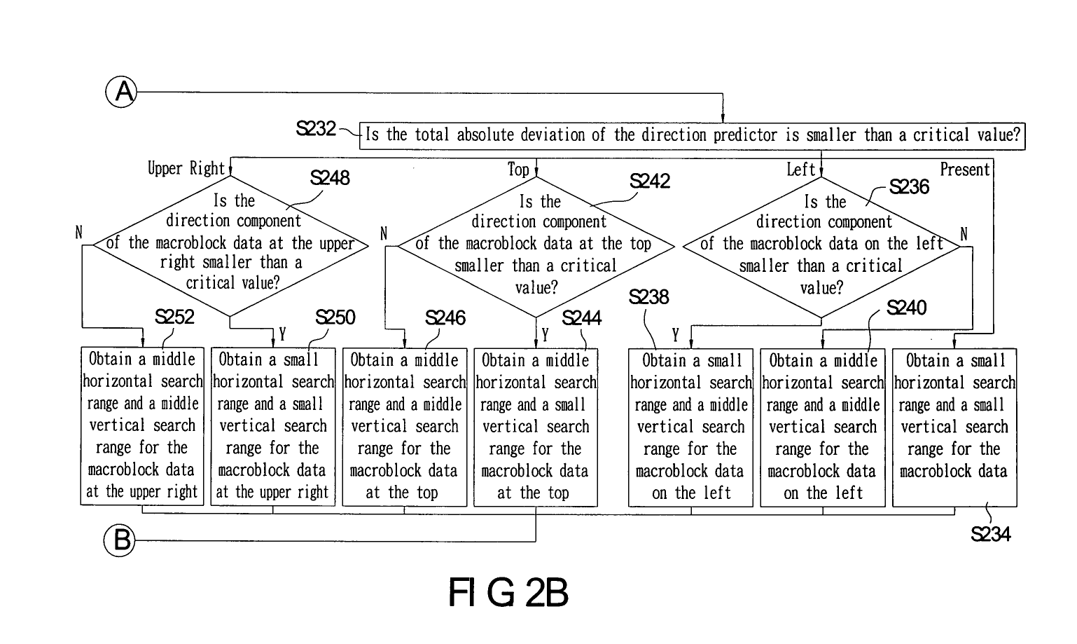

Referring to FIGS. 2A and 2B, detailed flow charts of a motion estimation method for an adaptive dynamic search range in accordance with the present invention are illustrated. The method further comprises the steps of: (S200) installing a direction predictor of a macroblock data, and the direction predictor includes the position of the macroblock data and its left, top and right positions of the macroblock data; (S202) finding out the smallest total absolute deviation from the position of the macroblock data and its left, top and right positions of the macroblock data; (S204) determining whether or not the smallest total absolute deviation is smaller than a critical value; (S210) determining the direction predictor as one with a total absolute deviation larger than a critical value, if the determination result obtained from (S204) is negative, and indicating that the direction predictor and the reference frame have a low similarity with each other; (S212) obtaining a middle horizontal search range and a middle vertical search range of the motion estimation vector of the macroblock data, if the direction predictor is a direction component of the macroblock data; (S214) determining whether or not the direction component of a motion estimation vector of the macroblock data on the left is smaller than a critical value of a motion estimation vector, if the direction predictor is a macroblock data on the left, and by that time the direction component of the motion estimation vector of the macroblock data on the left is determined as a horizontal component; (S216) obtaining a middle horizontal search range and a middle vertical search range of the motion estimation vector of the macroblock data on the left, if the determination result obtained from (S214) is affirmative; (S218) obtaining a large horizontal search range and a large vertical search range of the motion estimation vector of the macroblock data on the left, if the determination result obtained from (S214) is negative; (S220) determining whether or not a direction component of a motion estimation vector at the top of the macroblock data is smaller than a critical value of the motion estimation vector, if the direction predictor is a macroblock data at the top, and by that time the direction component is a vertical component; (S222) obtaining a middle horizontal search range and a middle vertical search range of the motion estimation vector of the macroblock data at the top, if the determination result obtained from (S220) is affirmative; (S224) obtaining a middle horizontal search range and a large vertical search range of the motion estimation vector of the macroblock data at the top, if the determination result obtained from (S220) is negative; (S226) determining whether or not a direction component of a motion estimation vector of a macroblock data at the upper right is smaller than a critical value of the motion estimation vector, if the direction predictor is a macroblock data at the upper right, wherein the direction component is a horizontal component or a vertical component; (S228) obtaining a middle horizontal search range and a middle vertical search range of the motion estimation vector of the macroblock data at the upper right, if the determination result from (S226) is affirmative and the direction component is the horizontal component or the vertical component; (S230) obtaining a large horizontal search range and a large vertical search range of the motion estimation vector of the macroblock data at the upper right, if the determination result from (S226) is negative and the direction component is the horizontal component or the vertical component; (S232) concluding that the direction predictor and the reference frame have a high similarity with each other, if the determination result of (S204) is affirmative; (S232) concluding that the direction predictor has a total absolute deviation smaller than a critical value; (S234) obtaining a small horizontal search range and a small vertical search range of the motion estimation vector of the macroblock data, if the direction predictor is a direction component of the macroblock data; (S236) determining whether or not a direction component of a motion estimation vector of a macroblock data on the left is smaller than a critical value of the motion estimation vector, if the direction predictor is a macroblock data on the left, wherein the direction component is a horizontal component; (S238) obtaining a small horizontal search range and a middle vertical search range of the motion estimation vector of the macroblock data on the left, if the determination result obtained from (S236) is affirmative; (S240) obtaining a middle horizontal search range and a middle vertical search range of the motion estimation vector of the macroblock data on the left, if the determination result obtained from (S236) is negative; (S242) determining whether or not a direction component of a motion estimation vector of a macroblock data at the top is smaller than a critical value of the motion estimation vector, if the direction predictor is a macroblock data at the top, wherein the direction component is a vertical component; (S244) obtaining a middle horizontal search range and a small vertical search range of the motion estimation vector of the macroblock data at top, if the determination result obtained from (S242) is affirmative; (S246) obtaining a middle horizontal search range and a middle vertical search range of the motion estimation vector of the macroblock data at top, if the determination result obtained from (S242) is negative; (S248) determining whether or not a direction component of a motion estimation vector of a macroblock data on the upper right is smaller than a critical value of the motion estimation vector, if the direction predictor is a macroblock data on the upper right, wherein the direction component is a horizontal component or a vertical component; (S250) obtaining a small horizontal search range and a small vertical search range of the motion estimation vector of the macroblock data at the upper right, if the determination result obtained from (S242) is affirmative and the direction component is a horizontal component or a vertical component; (S252) obtaining a middle horizontal search range and a middle vertical search range of the motion estimation vector of the macroblock data at the upper right, if the determination result obtained from (S242) is negative and the direction component is a horizontal component or a vertical component; and (S208) computing the total absolute value after the direction component search range of the direction component is obtained.

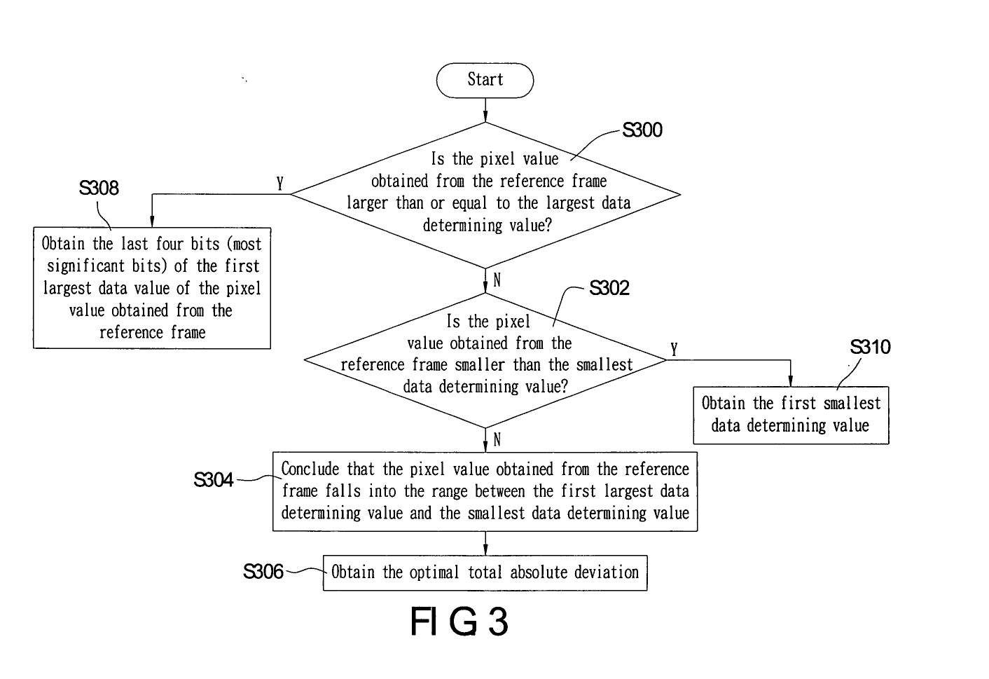

Referring to FIG. 3 for a flow chart of a method for calculating the total absolute value in accordance with the present invention, the method comprises the steps of: (S300) determining whether or not the pixel value obtained from the reference frame is larger than or equal to the first largest data determining value; wherein the method for calculating the total absolute deviation is a uniform distribution quantified hierarchical method, and the pixel value obtained from the reference frame is divided into 15 equal ranges according to the uniform distribution quantified hierarchical method, and the ranges include data of values from the smallest 0 to the largest 255; (S308) determining whether or not the pixel value obtained from the reference frame is larger, and if the determination result is affirmative, then the last four bits (which are the most significant four bits) of the first largest data value of that value are obtained; (S302) determining whether or not that value is smaller than a first smallest data determining value, if the determination result is negative; (S310) obtaining the first smallest data determining value, if the determination result obtained from (S302) is affirmative; (S304) concluding that the data falls in a range between the first largest data determining value and the smallest data determining data; and (S306) obtaining an optimal total absolute deviation.

The foregoing method for calculating the total absolute deviation is similar to the rounding-up algorithm, which coverts the data originally distributed in the range of 0 to 255 into a uniform quantified hierarchy. The conversion value set by the present invention is done by adding 8 to the original value. Since the four bits of the least significant byte of the value of each quantified hierarchy are 0 and the four bits of the least significant byte of the converted value are 0, therefore the largest conversion error is 8. The largest error of the prior art is 8, which directly uses the four bits of the most significant byte as the conversion value. Therefore, the conversion method provided by the invention can greatly reduce the error of calculating the total absolute deviation. Most importantly, when such conversion value is used for calculating the total absolute deviation to obtain the optimal search result, there is almost no deviation between the 8-bit total absolute deviation and the search result. The method for calculating the total absolute deviation in accordance with the present invention can be used effectively in integral motion estimation.

With the foregoing disclosed technology, the present invention provides a novel design over the prior arts and improves the overall application value, which complies with the patent application requirements. While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A motion estimation method for an adaptive dynamic search range, comprising the steps of:
installing a direction predictor of a macroblock data;
finding out a direction predictor having a minimum total absolute deviation;
determining whether or not said direction predictor is the minimum total absolute deviation and said minimum total absolute deviation is smaller than a critical value;
determining whether or not a direction component of a motion estimation vector of said macroblock data is smaller than a critical value of said motion estimation vector;
obtaining a direction component search range of said direction vector; and
computing a total absolute deviation of said direction component search range.

2. The motion estimation method for an adaptive dynamic search range of claim 1, wherein said direction predictor comprises a macroblock data location and its left, top and upper right locations of said macroblock data location.

3. The motion estimation method for an adaptive dynamic search range of claim 1, wherein said step of determining whether or not said direction predictor is the smallest total absolute deviation and said smallest total absolute deviation is smaller than a critical value includes the step of determining a motion estimation vector of said macroblock data if said determination is affirmative, or else includes the steps of:
obtaining a total absolute deviation of said direction predictor larger than a critical value and determining whether or not a direction component of said motion estimation vector of said macroblock data is smaller than a critical value of said motion estimation vector;
examining a direction component search range of said macroblock data; and
computing a total absolute deviation of said direction component search range.

4. The motion estimation method for an adaptive dynamic search range of claim 3, wherein said direction predictor comprises a macroblock data location and its left, top and upper right locations of said macroblock data location.

5. The motion estimation method for an adaptive dynamic search range of claim 4, wherein said total absolute deviation of said direction predictor is larger than a critical value, indicating that said direction predictor and said reference frame have a 16w similarity with each other, and if said direction predictor is a component vector of said macroblock data, then a middle horizontal search range and a middle vertical search range of said motion estimation vector of said macroblock data will be obtained.

6. The motion estimation method for an adaptive dynamic search range of claim 4, wherein said direction predictor has a total absolute deviation larger than a critical value, indicating that said direction predictor and said reference frame have a low similarity with each other, and if said direction predictor is a macroblock data on the left, then determine whether or not a direction component of a motion estimation vector of said macroblock data on the left is smaller than a critical value of said motion estimation vector, and said direction component is a horizontal component; if said determination result is affirmative, then a middle horizontal search range and a middle vertical search range of said motion estimation vector of said macroblock data on the left will be obtained; if said determination result is negative, then a large horizontal search range and a middle vertical search range of said motion estimation vector of said macroblock data on the left will be obtained.

7. The motion estimation method for an adaptive dynamic search range of claim 4, wherein said direction predictor has a total absolute deviation larger than a critical value, indicating that said direction predictor and said reference frame have a low similarity with each other, and if said direction predictor is a macroblock data at the top, then determine whether or not a direction component of a motion estimation vector of said macroblock data at the top is smaller than a critical value of said motion estimation vector, and said direction component is a vertical component.

8. The motion estimation method for an adaptive dynamic search range of claim 7, wherein said step of determining whether or not a direction component of a motion estimation vector of said macroblock data at the top is smaller than a critical value of said motion estimation vector comes up with an affirmative determination result, and a middle horizontal search range and a middle vertical search range of said motion estimation vector of said macroblock at the top will be obtained; on the contrary, if said determination result is negative, then a middle horizontal search range and a large vertical search range of said motion estimation vector of said macroblock at the top will be obtained.

9. The motion estimation method for an adaptive dynamic search range of claim 4, wherein said direction predictor has a total absolute deviation larger than a critical value, indicating that said direction predictor and said reference frame have a low similarity with each other, and if said direction predictor is a macroblock data on the right, then determine whether or not a direction component of a motion estimation vector of said macroblock data on the right is smaller than a critical value of said motion estimation vector, and said direction component is a horizontal component or a vertical component; if said determination result is affirmative and said direction component is a horizontal component or a vertical component, then a middle horizontal search range and a middle vertical search range of said motion estimation vector of said macroblock data on the right are obtained; on the contrary, if said determination result is negative and said direction component is a horizontal component or a vertical component, then a large horizontal search range and a large vertical search range of said motion estimation vector of said macroblock data on the right will be obtained.

10. The motion estimation method for an adaptive dynamic search range of claim 3, wherein said total absolute deviation is calculated by a uniform distribution quantified hierarchical method comprising the steps of:
determining whether or not a pixel value obtained from said reference frame is larger than or equal to a first largest data determining value, and said pixel value is divided into 15 equal ranges according to said uniform distribution quantified hierarchical method, and said equal ranges have data values from the smallest 0 to the largest 255;
determining said pixel value obtained from said reference frame is smaller than a first smallest data determining value;
obtaining four bits (which are the most significant bits) after adding 8 to said pixel value, if said pixel value falls into the range between said first largest data determining value and said first smallest data determining value; and
obtaining an optimal absolute deviation.

11. The motion estimation method for an adaptive dynamic search range of claim 10, wherein said step of determining whether or not said pixel value is larger comes up with an affirmative determination result affirmative, and the last four bits (which are the most significant bits) from said largest data value of said pixel value are obtained; if said determination result is negative, then determine whether or not said pixel value is smaller than a first smallest data determining value.

12. The motion estimation method for an adaptive dynamic search range of claim 10, wherein said first smallest data determining value will be obtained if said step of determining whether or not said pixel value is smaller comes up with an affirmative determination result; on the contrary, if said determination result is negative, a value falling between said first largest data determining value and said first smallest data determining value will be processed.

13. The motion estimation method for an adaptive dynamic search range of claim 1, wherein said step of determining a motion estimation vector of said macroblock data comes up with an affirmative determination result, and a direction component search range of said direction component is obtained; on the contrary, if said determination result is negative, said motion estimation method further comprises the steps of:
determining a direction component of a motion estimation vector of said macroblock data being larger than a critical value of said motion estimation vector; and
examining a direction component search range of said macroblock data.

14. The motion estimation method for an adaptive dynamic search range of claim 2, wherein said direction predictor has a total absolute deviation smaller than a critical value, indicating that said direction predictor and said reference frame have a high similarity with each other, and if said direction predictor is a component vector of said macroblock data, then a small horizontal search range and a small vertical search range of said motion estimation vector of said macroblock data will be obtained.

15. The motion estimation method for an adaptive dynamic search range of claim 2, wherein said direction predictor has a total absolute deviation smaller than a critical value, indicating that said direction predictor and said reference frame have a high similarity with each other, and if said direction predictor is a macroblock data on the left, then determine whether or not a direction component of a motion estimation vector of said macroblock data on the left is smaller than a critical value of said motion estimation vector, and said direction component is a horizontal component; if said determination result is affirmative and said direction component is a horizontal component or a vertical component, then a small horizontal search range and a middle vertical search range of said motion estimation vector of said macroblock data on the left will be obtained; on the contrary, if said determination result is negative, then a middle horizontal search range and a middle vertical search range of said motion estimation vector of said macroblock data on the left will be obtained.

16. The motion estimation method for an adaptive dynamic search range of claim 2, wherein said direction predictor has a total absolute deviation smaller than a critical value, indicating that said direction predictor and said reference frame have a high similarity with each other, and if said direction predictor is a macroblock data at the top, then determine whether or not a direction component of a motion estimation vector of said macroblock data at the top is smaller than a critical value of said motion estimation vector, and said direction component is a horizontal component; if said determination result is affirmative and said direction component is a vertical component, then a middle horizontal search range and a small vertical search range of said motion estimation vector of said macroblock data at the top will be obtained; on the contrary, if said determination result is negative, then a middle horizontal search range and a middle vertical search range of said motion estimation vector of said macroblock data at the top will be obtained.

17. The motion estimation method for an adaptive dynamic search range of claim 2, wherein said direction predictor has a total absolute deviation smaller than a critical value, indicating that said direction predictor and said reference frame have a high similarity with each other, and if said direction predictor is a macroblock data at the upper right, then determine whether or not a direction component of a motion estimation vector of said macroblock data at the upper right is smaller than a critical value of said motion estimation vector, and said direction component is a horizontal component; if said determination result is affirmative and said direction component is a horizontal component or a vertical component, then a small horizontal search range and a small vertical search range of said motion estimation vector of said macroblock data at the upper right will be obtained; on the contrary, if said determination result is negative and said direction component is a horizontal component or a vertical component, then a middle horizontal search range and a middle vertical search range of said motion estimation vector of said macroblock data at the upper right will be obtained.

18. The motion estimation method for an adaptive dynamic search range of claim 1, wherein said total absolute deviation is calculated by a uniform distribution quantified hierarchical method comprising the steps of:
determining whether or not a pixel value obtained from said reference frame is larger than or equal to a first largest data determining value, and said pixel value is divided into 15 equal ranges according to said uniform distribution quantified hierarchical method, and said equal ranges have data values from the smallest 0 to the largest 255;
determining whether or not said pixel value obtained from said reference frame is smaller than a first smallest data determining value;
obtaining four bits (which are the least significant bits) after adding 8 to said pixel value, if said pixel value falls into the range between said first largest data determining value and said first smallest data determining value; and
obtaining an optimal absolute deviation.

19. The motion estimation method for an adaptive dynamic search range of claim 18, wherein said four bits (which are the least significant bits) after adding 8 to said pixel value are obtained, if said step of determining whether or not said pixel value is larger comes up with an affirmative determination result; on the contrary, if said determination result is negative, then said pixel value is smaller than a first smallest data determining value.

20. The motion estimation method for an adaptive dynamic search range of claim 18, wherein said first largest data determining value is obtained, if said step of determining whether or not said pixel value is larger comes up with an affirmative determination result; on the contrary, if said determination result is negative, then said data falling into the range between said first largest data determining value and said first smallest data determining value will be processed.
